(19) United States
(12) Patent Application Publication
(10) Pub. No.: US 2011/0007048 A1
(43) Pub. Date: Jan. 13, 2011

(54) SYSTEM AND METHOD FOR USING PIXELS OF A DISPLAY DEVICE TO COMMUNICATE OPTICAL INFORMATION OVER A COMMUNICATIONS LINK

(75) Inventors: Roger A. Fratti, Mohnton, PA (US); Cathy L. Hollien, Bridgewater, NJ (US)

Correspondence Address: SMITH FROHWEIN TEMPEL GREENLEE BLAHA LLC, TWO RAVINIA DRIVE, SUITE 700, ATLANTA, GA, 30346, US

(73) Assignee: AGERE SYSTEMS INC., Allentown, PA (US)

(21) Appl. No.: 12/922,704

(22) PCT Filed: May 10, 2008
(86) PCT No.: PCT/US08/63349

§ 371 Date: Sep. 15, 2010

(51) Int. Cl. G09G 3/36; G09G 5/00

(52) U.S. Cl. 345/207; 345/87

(57) ABSTRACT

A system for communicating over an optical communications link is provided that uses at least one display pixel of a display device to transmit optical information bits and at least one sensor pixel of the display device to receive optical information bits. To transmit optical information bits, a controller of the display device causes the transmitter display pixel to switch between at least first and second optical display conditions to produce a modulated optical signal representative of one or more information bits. To receive optical information bits, the controller reads the electrical sense signal produced by the receiver sensor pixel and interprets the electrical sense signal read from the receiver pixel as corresponding to one or more information bits.

### TECHNICAL FIELD OF THE INVENTION

The invention relates to display devices, and more particularly, to a display device having functionality for transmitting and/or receiving an optical data signal.

### BACKGROUND OF THE INVENTION

Electronic devices such as personal digital assistants (PDAs) and calculators, for example, often include infrared (IR) emitters and detectors for emitting and detecting, respectively, optical data signals. The IR emitter, which is typically an IR light emitting diode (LED), is biased on and off by an electrical signal output from an electrical driver circuit. The on/off biasing of the LED causes it to produce a modulated optical data signal. The IR detector, which is typically an IR photodiode, receives the modulated optical data signal and converts it into an electrical data signal. Demodulation and decoder circuitry demodulates the electrical signal and decodes the demodulated signal to recover the data.

One of the disadvantages of using an IR communications link of the type described above is that it requires relatively expensive components, such as the IR LED, for example. In addition, the IR LED used in the link consumes a relatively large amount of power, which is undesirable, especially with regard to portable electronics devices.

Accordingly, a need exists for an optical communications link that is suitable for use with various types of portable electronic devices, such as, for example, mobile phones and PDAs, and which does not require the use of IR emitters (e.g., IR LEDs) and IR detectors (e.g., photodiodes).

### SUMMARY OF THE INVENTION

The invention is directed to a system and method that uses pixels to transmit and receive optical signals representing information bits over an optical communications link. The system comprises at least a first electronics device comprising at least a first display device and a first controller. The first display device includes a plurality of display pixels and a plurality of sensor pixels. Each display pixel is controllable by the first controller to switch between at least first and second optical display conditions. Each sensor pixel is capable of sensing light and of producing an electrical sense signal associated with the sensed light. At least one of the display pixels is used as a first transmitter pixel and at least one of the sensor pixels is used as a first receiver pixel. The first controller is configured to receive one or more information bits to be transmitted over an optical communications link and to cause the first transmitter pixel to switch between the optical display conditions to produce a modulated optical signal representative of one or more information bits. The first controller is configured to read the electrical sense signal produced by the first receiver pixel and to interpret the electrical sense signal as corresponding to one or more information bits received over the optical communications link.

The method comprises providing at least a first electronics devices having a display device and a controller, at least one display pixel of the display device being used as a first transmitter pixel and at least one sensor pixel of the display device being used as a receiver pixel. The controller receives one or more information bits to be transmitted over an optical communications link and causes the transmitter pixel to switch between at least first and second optical display conditions to produce a modulated optical signal representative of one or more information bits.

These and other features and advantages of the invention will become apparent from the following description, drawings and claims.

### BRIEF DESCRIPTION OF THE DRAWINGS

FIG. 1 illustrates a block diagram of a pixel of a known AMLCD display device that is suitable for providing the optical transmitter and receiver functionality of the invention.

FIG. 2 illustrates a block diagram of a system in accordance with an illustrative embodiment for providing an optical communications link.

FIG. 3 illustrates two electronics devices that each include an AMLCD display device of the type depicted in FIG. 2.

FIGS. 4A and 4B illustrate flowcharts that represent a method in accordance with an embodiment for using pixels of display devices to communicate optical information signals over an optical communications link.

FIG. 5 illustrates a flowchart that represents a method in accordance with an illustrative embodiment for selecting the area of the display device that is to be used to transmit and receive optical signals.

FIG. 6 illustrates a flowchart that represents a method in accordance with another embodiment for using pixels of display devices to communicate optical information signals between two electronics devices.

### DETAILED DESCRIPTION OF AN ILLUSTRATIVE EMBODIMENT

In accordance with the invention, an active matrix liquid crystal display (AMLCD) device is used as an optical receiver and/or as an optical transmitter of an optical communications link, thereby obviating the need to use IR LEDs and IR detectors in optical communications devices. An AMLCD device is a display device that is currently used in various types of consumer electronics devices for displaying images. An AMLCD device includes layers of optically transmissive material within which red, green and blue (RGB) photosensitive materials and switching circuitry are “sandwiched”. The switching circuitry functions to selectively activate and deactivate the quantities of RGB photosensitive materials. Quantities of R material, B material and G material and respective R, G, B switching circuitry form a respective display pixel. The AMLCD display device is made up of many such display pixels arrayed in rows and columns, and includes driver circuitry coupled to the switching circuitry of the display pixels for driving the pixels. Activation of one or more of the R, G, B quantities of each pixel causes the pixel to display a corresponding color.

At least one manufacturer of AMLCD display devices, Sharp Electronics Corporation, has begun including a photodetector, i.e., a photodiode or phototransistor, in each pixel of the AMLCD device. The photodetector provides the AMLCD device with touch sensing capability. When something, such as a finger or stylus, for example, is placed in contact with an area on the display device, the photodetectors of the pixels sense the intensity level of the light in the contacted area and convert the light into electrical current signals. These electrical current signals provide an indication that the corresponding area on the display device has been contacted, or touched. In accordance with the invention, one or more of these photodetectors of one or more of the respective pixels of the AMLCD device is used as an optical receiver of an optical communications link. Activation and deactivation of one or more of the R, G, B quantities of one or more of the pixels provides an optical transmitter of an optical communications link.

When two electronics devices such as, for example, a PDA and a personal computer (PC), having AMLCD display devices configured with this optical receiver and optical transmitter functionality are located in proximity to one another, the electronics devices are able to communicate information between them over an optical communications link between the optical transmitter and the optical receiver. The R, G, B quantities of the pixel or pixels that make up the optical transmitter of one of the portable devices are activated and deactivated to provide a shuttering effect that produces a modulated optical information signal. The photodetector of the pixel or pixels that make up the optical receiver of the other of the portable devices detects the modulated optical information signal and produces an associated electrical signal, which is then demodulated by demodulation circuitry of the electronics device to recover the information that was contained in the modulated optical information signal.

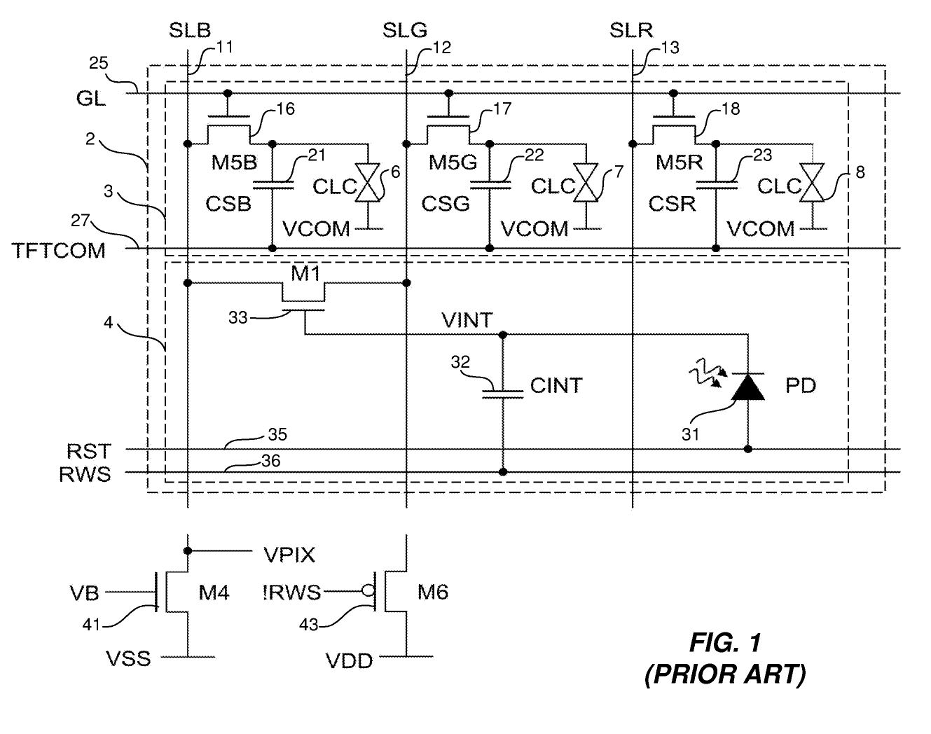

FIG. 1 illustrates a block diagram of a pixel 2 of a known AMLCD display device that is suitable for providing the optical transmitter and receiver functionality of the invention. The pixel 2 includes a display pixel portion 3 and a sensor pixel portion 4. The display pixel portion 3 includes cholesteric liquid crystals (CLCs) 6, 7 and 8, which are transmissive when activated and opaque when deactivated. The AMLCD device that incorporates the pixel 2 is typically backlit and uses color filters such that activation of the CLCs 6, 7 and/or 8 causes the display device to display blue, green and/or red wavelengths of light, respectively, at the pixel location. Activation and deactivation of the CLCs 6, 7 and 8 is performed by selecting and deselecting display pixel column lines 11, 12 and 13, respectively. The selection and deselection of the column lines 11, 12 and 13 is performed by switching circuitry (not shown) external to the pixel 2. One side of each CLCs 6, 7 and 8 is connected to a common bias voltage, VCOM. The other sides of the CLCs 6, 7 and 8 are coupled to respective drains of respective n-type low-temperature polysilicon thin-film transistors (TFTs) 16, 17 and 18.

The gates of the TFTs 16, 17 and 18 are connected to a control line 25 that is selected and deselected by the external switching circuitry to activate and deactivate the TFTs 16, 17 and 18. Capacitors 21, 22 and 23 are connected on one end thereof to the drains of the TFTs 16, 17 and 18, respectively, and on the opposite ends thereof to a TFT common bias voltage, TFTCOM, provided on line 27. Charging of the capacitors 21, 22 and 23 provides the electric fields needed for altering the phases of the CLCs 6, 7 and 8, respectively. When the TFTs 16, 17 and 18 are in the active state, data is written to the CLCs 6, 7 and/or 8 by selecting the respective column lines 11, 12 and/or 13.

The sensor pixel portion 4 of the pixel 2 is a one-transistor (1-T) sensor pixel circuit comprising a photodiode 31, an integration capacitor 32 and an n-type polysilicon TFT 33. The anode of the photodiode 31 is connected to a reset control line, RST 35, and the cathode of the photodiode 31 is connected to the gate of the TFT 33. One side of the capacitor 32 is connected to a row select line, RWS 36, and the other side of the capacitor 32 is connected to the gate of the TFT 33. The source and drain of the TFT 33 are connected to the column lines 11 and 12, respectively. External to the pixel 2, the source of an n-type TFT 41 is connected to the source of TFT 33, and the drain of TFT 41 is connected to a supply voltage, VSS. The output of the sensor pixel portion 4, VPIX, is a terminal connected to the source of the TFT 41. The drain of the TFT 33 is connected to the source of a p-type TFT 43. The drain of the TFT 43 is connected to a supply voltage VDD.

The manner in which the pixel 2 operates is known in the art. Generally, the column lines 11, 12 and 13 are used for both writing the display pixel portion 3 and for reading the sensor pixel portion 4. The sensor pixel portion 4 is read during the row blanking period of the display pixel portion 3. Because the sensor pixel portion 4 is read during the row blanking period of the display pixel portion 3, the integration of the sensor pixel portion 4 with the display pixel portion 3 is made possible without having to change the timing of the display pixel portion 3.

As indicated above, the sensor pixel portion 4 of the pixel 2 is normally used to provide the AMLCD device with touch sensing functionality. In accordance with the invention, it has been determined that the sensor pixel portion 4 may be used to provide an optical receiver of an optical communications link and that the display pixel portion 3 may be used to provide an optical transmitter of an optical communications link. Examples of the manner in which this may be accomplished will now be described with reference to a few illustrative embodiments.

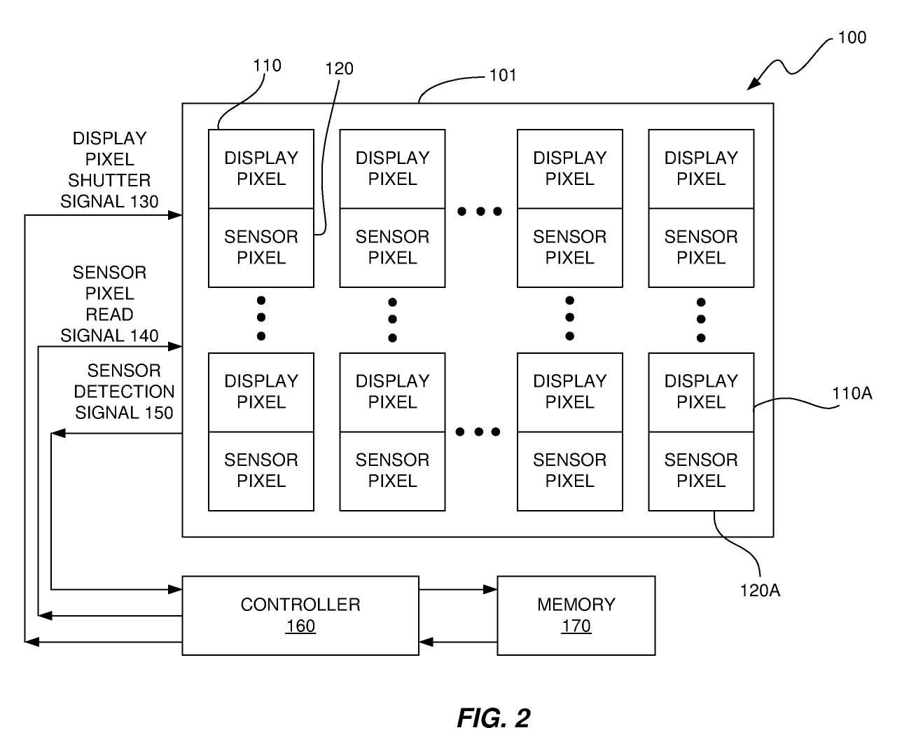

FIG. 2 illustrates a block diagram of a system 100 in accordance with an illustrative embodiment for providing an optical communications link. The system 100 includes a display device 101, a controller 160 and a memory device 170. The display device 101 includes display pixels 110 and sensor pixels 120, which may be identical or similar to the display pixel portion 3 and the sensor pixel portion 4, respectively, described above with reference to FIG. 1. Most of the display and sensor pixels 110 and 120, respectively, are used in the typical manner for displaying images and sensing touch, respectively. However, in accordance with this embodiment, the display and sensor pixels 110A and 120A, respectively, located in the bottom right-hand portion of the display device 100 are used as an optical transmitter and an optical receiver, respectively. It should be noted, however, that one or more of the display pixels 110 may be used as the optical transmitter and that one or more of the sensor pixels 120 may be used as the optical receiver. Also, as will be described below in more detail, the display and sensor pixels that are used for these purposes need not be at fixed locations in the display device, but may be selected during a training or calibration sequence prior to transmitting or receiving information over the optical communications link.

The display device 101 receives a display pixel shutter signal 130 that causes the display pixel 110A comprising the optical transmitter to be activated and deactivated. For demonstrative purposes, it will be assumed that activation of the display pixel 110A causes it to become transmissive such that it allows light from a backlighting source (not shown) to pass through the display pixel 110A and be emitted from the display device 101. Deactivation of the display pixel 110A causes it to become opaque such that light emitted by the backlighting source is prevented from passing through the display pixel 110A, thereby preventing light from being emitted from the display device 101. Thus, the display pixel shutter signal 130 modulates the display pixel 110A by activating and deactivating it in accordance with an information signal to be transmitted, thereby causing the display pixel 110A to emit an optical information signal.

The display pixel shutter signal 130 typically comprises a combination of multiple signals carried on multiple respective signal lines, such as signals on signal lines 11, 12, 13, 25, and 27 in FIG. 1 for controlling activation and deactivation of the blue, green and red CLCs 6, 7 and 8. In the case in which the display pixel 110A includes a blue CLC, a green CLC and a red CLC, typically the shutter signal 130 will cause all of the CLCs to be simultaneously activated and simultaneously deactivated. For example, simultaneous activation of all of the CLCs of the display pixel 110A will cause the display device 101 to emit white light at the location of the pixel 110A. Simultaneous deactivation of all of the CLCs of the display pixel 110A will cause the display device 100 to become dark at the location of the pixel 110A. During a transmission interval or sequence, emission of white light at the location of the display pixel 110A may correspond to transmission of a binary “1”, whereas emission of no light at the location of the display pixel 110A may correspond to transmission of a binary “0”. Alternatively, emission of white light at the location of the display pixel 110A may correspond to transmission of a binary “0”, whereas emission of no light at the location of the display pixel 110A may correspond to transmission of a binary “1”. The invention is not limited with respect to the type of modulation protocol that is used for this purpose.

A sensor pixel read signal 140 is also applied to the display device 101. The sensor pixel read signal 140 causes a voltage signal indicative of the state of the sensor pixel 120A to be output from the display device 100 as sensor detection signal 150. The sensor detection signal 150 will have a state that is indicative of the optical energy detected by the photodetector of the sensor pixel 120A. The sensor pixel read signal 140 typically comprises a combination of multiple signals carried on multiple respective signal lines, such as signals on the signal lines 11, 12, 35, and 37 shown in FIG. 1 for controlling reading of the photodetector of the sensor pixel 120A. During operation of the optical communications link, if the level of the sensor detection signal 150 is high, this may be interpreted as receipt of a binary “1”, whereas if the level of the sensor detection signal 150 is low, this may be interpreted as receipt of a binary “0”. Alternatively, if the level of the sensor detection signal 150 is high, this may be interpreted as receipt of a binary “0”, whereas if the level of the sensor detection signal 150 is low, this may be interpreted as receipt of a binary “1”. Again, the invention is not limited with respect to the type of modulation protocol that is used for this purpose.

The controller 160 controls the states of the signals 130 and 140 to control the transmission and reception, respectively, of bits over the optical communications link. The controller 160 also receives and decodes the signal 150 to detect whether a received bit is a binary 1 or a binary 0. The controller 160 may include one or more integrated circuits (ICs), such as, for example, a microprocessor, a microcontroller, and application specific integrated circuit (ASIC), a programmable gate array (PGA), a programmable logic array (PLA), etc. The controller 160 may also include one or more other components, such as, for example, amplifiers, filters, resistors, capacitors, inductors, clock recovery circuits, analog-to-digital converters (ADCs), digital-to-analog converters (DACs), etc. As will be described below in more detail, one of the ICs of the controller 160 is typically some type of processor that is programmed with software and/or firmware for performing tasks associated with transmitting and receiving bits over the optical communications channel. The computer code corresponding to the software and/or firmware and other data is typically stored in the memory device 170. The memory device 170 is some type of computer-readable medium such as, for example, a solid state memory device, an optical storage device, a magnetic storage device, etc.

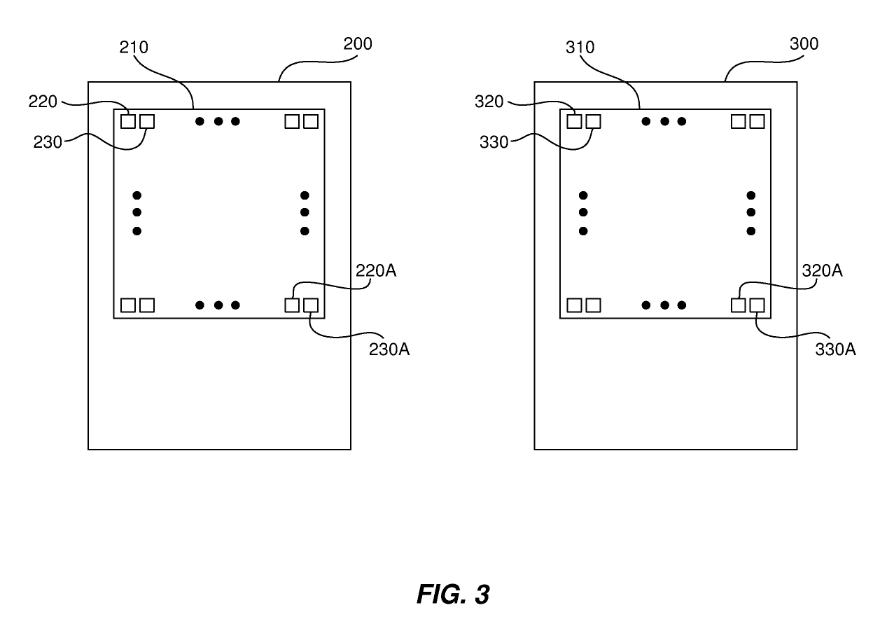

FIG. 3 illustrates two electronics devices 200 and 300, each of which includes an AMLCD display device 210 and 310, respectively, of the type described above with reference to FIG. 2. The electronics devices 200 and 300 may be any type of electronics devices that include display devices and for which it would be advantageous to provide an optical communications link to allow the devices to communicate with each other. For example, one of the devices 200 may be a PDA or mobile phone and the other device 300 may be a PC, or a television set. Although FIG. 3 depicts the electronics devices 200 and 300 being of the same size and shape, the devices 200 and 300 may be of different sizes and shapes and may have display devices 210 and 310 that are of different sizes and shapes.

The display device 210 includes a plurality of display pixels 220 and a plurality of sensor pixels 230. At least one of the display pixels 220A and at least one of the sensor pixels 230A of the display device 210 is used as the optical transmitter and the optical receiver, respectively, of the optical communications link. Likewise, the display device 310 includes a plurality of display pixels 320 and a plurality of sensor pixels 330. At least one of the display pixels 320A and at least one of the sensor pixels 330A of the display device 310 is used as the optical transmitter and the optical receiver, respectively, of the optical communications link. Thus, the display and sensor pixels 220A and 230A act as the optical transmitter and optical receiver, respectively, on one side of the optical communications link, and the display and sensor pixels 320A and 330A act as the optical transmitter and optical receiver, respectively, on the other side of the optical communications link. In the illustrative embodiment represented in FIG. 3, the optical transmitters and optical receivers of the link correspond to the display pixels 220A, 320A and sensor pixels 230A, 330A located in the bottom right-hand portion of the display device 210, 310.

In order to allow the electronics devices 200 and 300 to communicate with each other, the devices 200 and 300 are placed in close proximity to one another with their display devices 210 and 310 generally facing each other such that the display and sensor pixels 220A and 230A are generally or exactly in the same optical path as the display and sensor pixels 320A and 330A. A communications session is then commenced during which the display pixels 220A and 320A transmit optical signals that are received by the sensor pixels 330A and 230A, respectively. This sequence may be commenced by a user activating a selection switch on each of the electronics devices 200 and 300. The selection switch may be, for example, an electromechanical switch located on the housings of the devices 200 and 300 or it may be a soft switch such as an icon of a graphical user interface (GUI) displayed on the display device. The display pixel 220A and the sensor pixel 230A need not be exactly aligned in an optical path with the sensor pixel 330A and the display pixel 320A. Presumably, the only pixels that will be activated during a communications session are those being used as the transmitter pixels. Therefore, even if the pixels are not precisely aligned, the sensor pixels 230A and 330A will only detect the signals transmitted by the respective display pixels 220A and 320A. Also, as described above with reference to FIG. 1, the sensor pixel is read during the row blanking period of the display pixel. Therefore, there is no danger of the sensor pixels 230A and 330A sensing the light produced by the display pixels 220A and 320A, respectively.

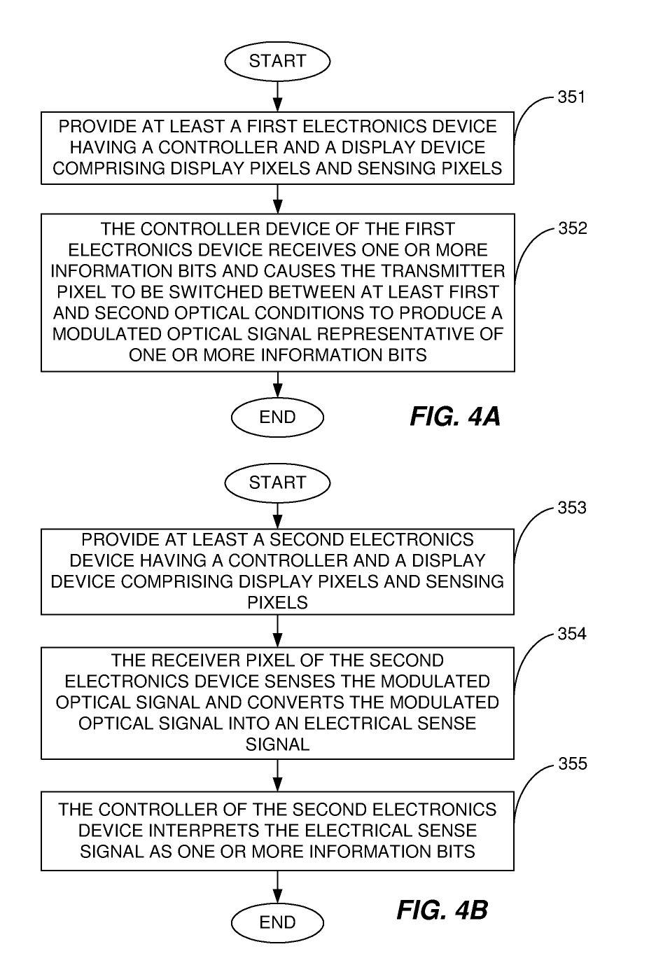

FIGS. 4A and 4B illustrate flowcharts that represent a method in accordance with an embodiment for using pixels of a display device to communicate optical information signals over an optical communications link. With reference to FIG. 4A, at least a first electronics device is provided that has a controller and a display device having display pixels and sensor pixels, as indicated by block 351. One or more of the display pixels will be used as a transmitter pixel and one or more sensor pixels will be used as a receiver pixel. The controller receives one or more information bits to be transmitted over the optical communications link and causes its transmitter pixel to switch between at least first and second optical display conditions to produce a first modulated optical signal representative of one or more information bits, as indicated by block 352. The first electronics device then causes the modulated optical signal to be transmitted over an optical communications link, as indicated by block 353.

With reference to FIG. 4B, at least a second electronics device is provided, as indicated by block 354. In the second electronics device, the receiver pixel senses the modulated optical signal and converts it into an electrical sense signal, as indicated by block 355. The controller of the second electronics device receives the electrical sense signal produced by the receiver pixel and interprets the signal as one or more information bits, as indicated by block 356.

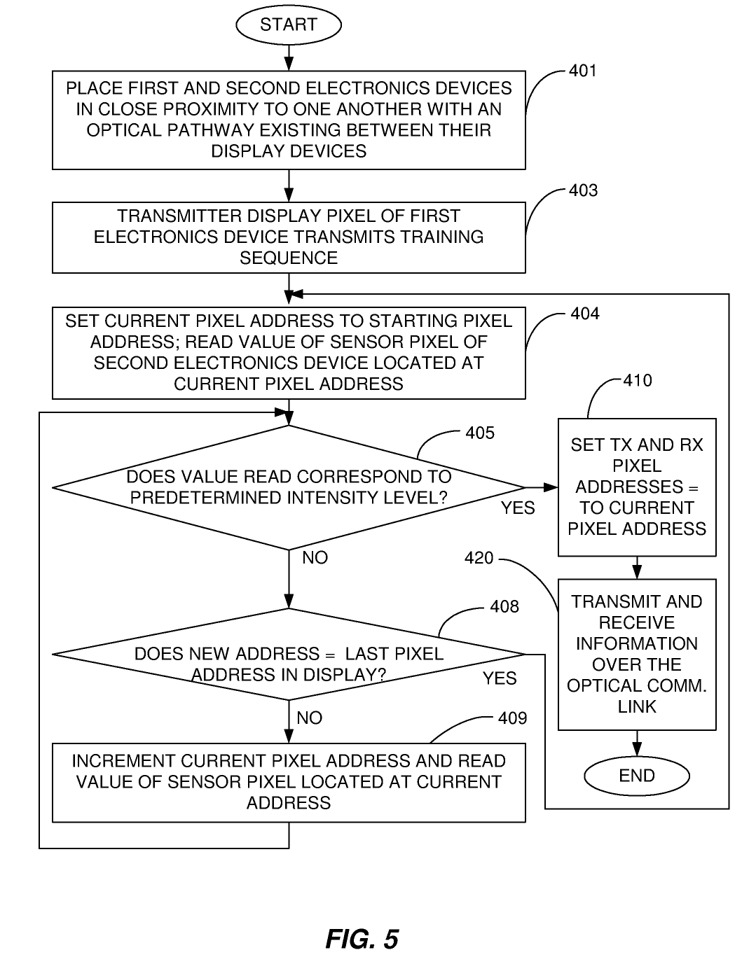

As an alternative to the transmitter and receiver pixels being in fixed locations, they may be selected at the beginning of or prior to the communications session during a training sequence, as will now be described with reference to FIG. 5. FIG. 5 illustrates a flowchart that represents the method in accordance with an illustrative embodiment for selecting the area of the display device that is to be used to transmit and receive optical signals. In other words, the pixels that will function as the transmitter and receiver pixels are selectable. This is especially useful in situations in which the display devices are different in size, which is typically true when the electronics devices are dissimilar (e.g., a mobile phone and a PC).

Assuming that one of the electronics devices has transmitter and receiver pixels that have already been set or designated, the other electronics device will perform an algorithm as will now be described that allows the other electronics device to select transmitter and receiver pixels that are at locations in the display device closest to the transmitter and receiver pixels of the other electronics device. To accomplish this, a training sequence is used during which the fixed transmitter pixel of one of the electronics devices is activated or modulated while the sensor pixels of the other electronics device are read in and a determination is made as to which sensor pixel is sensing the greatest intensity. The sensor pixel that is sensing the greatest intensity will be used as the optical receiver, and the display pixel at that same address will be used as the optical transmitter.

With reference to FIG. 5, at the commencement of the training sequence, the first electronics device for which the transmitter and receiver pixels have already been set is placed in close proximity to the second electronics device with their display devices facing each other such that an optical pathway exists between them, as indicated by block 401. The transmitter pixel of the first electronics device transmits the training sequence, as indicated by block 403. The training sequence is typically a series of binary 1s and 0s, but may be as simple as activating the transmitter pixel and keeping it activated until the completion of the training sequence. A current pixel address of the sensor pixel of the second electronics device is set to a starting pixel address of the first pixel in the display to be read and the value of the sensor pixel at that location is read, as indicated by block 404. A determination is made as to whether the sensed value of the sensor pixel located at the current address corresponds to a predetermined intensity level or series of predetermined intensity levels, as indicated by block 405. This may be accomplished by, for example, determining whether the sensor pixel is sensing an intensity level corresponding to a binary 1 or whether the sensor pixel is sensing a series of intensity levels corresponding to a predetermined pattern on binary 1s and 0s.

If it is determined at block 405 that the sensor pixel at the starting address is not sensing the predetermined intensity level or series of intensity levels corresponding to the training sequence, then a determination is made at block 408 as to whether or not the current pixel address is equal to the address of the last pixel in the display device. If not, then the current pixel address is incremented and the sensor pixel at the new current pixel address is read, as indicated by block 409. The process then returns to block 405, where a determination is made as to whether the intensity level sensed by the sensor pixel at the current pixel address is at the predetermined intensity level corresponding to the training sequence. If so, the process proceeds to block 410 where the addresses of the transmitter sensor pixel and receiver display pixel of the second electronics device are set equal to the current pixel address. Information in the form of optical signals may then be transmitted and received over the optical communications link, as indicated by block 420.

The process may terminate at the end of the communications session. Termination of the communications session may be triggered by one or more events, such as, for example, removal of the optical pathway between the display devices, detection of a bit sequence that indicates that the session has ended or that no information remains to be transmitted, etc.

If a determination is made at block 408 that the current pixel address is equal to the address of the last pixel in the display device (i.e., all of the sensor pixels in the display device have been read and processed), then the process returns to block 404 and repeats. In other words, the process continues to scan through the columns and rows of the sensor pixels of the second electronics device until a determination is made at block 405 that the current sensor pixel has sensed the training sequence. Alternatively, a timer or counter could be used so that if the training sequence is not detected after a given number of iterations of the process, the process terminates. Other events could be used as triggers to cause the process to terminate, such as, for example, actuation of a switch by a user.

It should be noted that the process depicted in FIG. 5 may be performed in a number of different ways to achieve the goals of the invention. For example, rather than the value of each sensor pixel being analyzed to determine whether it is equal to or greater than a predetermined intensity level and therefore corresponds to the training sequence, all of the sensor pixels could be read and the values compared to each other to determined which sensor pixel has sensed the highest value. The sensor pixel that has sensed the highest value may then be used as the receiver sensor pixel and the display pixel beside it, i.e., the display pixel at the same pixel address, may be used as the transmitter display pixel. Those skilled in the art will understand, in view of the description provided herein, the manner in which modifications may be made to the algorithm described above with reference to FIG. 5 to achieve the goals of the invention.

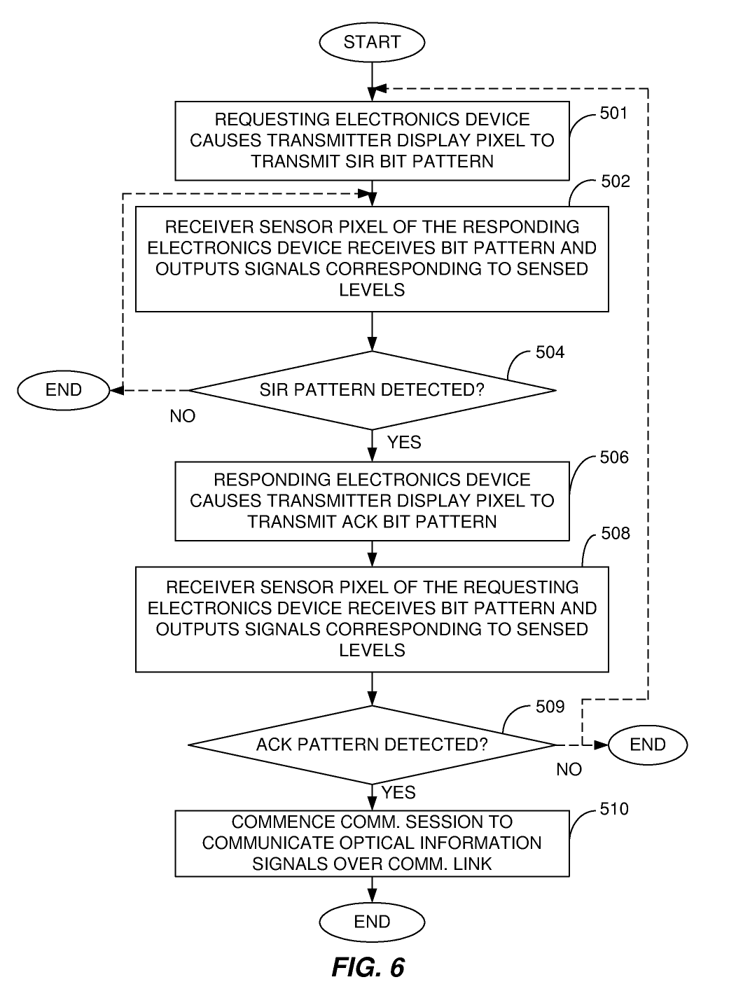

FIG. 6 illustrates a flowchart that represents a method in accordance with another embodiment for using pixels of display devices to communicate optical information signals between two electronics devices. In accordance with this embodiment, it is assumed that the transmitter display pixels and the receiver sensor pixels of the display devices either are at fixed locations in the display devices or are at locations that have previously been selected using a technique such as the training sequence algorithm described above with reference to FIG. 5 or by using some other suitable technique. Typically, the electronics device that is initiating the communication session will cause a bit pattern corresponding to a session initiation request (SIR) to be transmitted, as indicated by block 501. This electronics device will be referred to as the requesting electronics device and the other electronics device will be referred to as the responding electronics device. The receiver sensor pixel of the responding electronics device detects the bit pattern and outputs signals representing the corresponding intensity levels, as indicated by block 502. A determination is then made by circuitry of the responding electronics device as to whether the SIR bit pattern has been detected, as indicated by block 504. If so, the responding electronics device causes the transmitter display pixel to transmit a bit pattern acknowledging (ACK) receipt of the SIR bit pattern, as indicated by block 506. If not, the process being performed by the responding electronics device may terminate, or it may repeat continuously or periodically by returning immediately or after a predetermined delay period to block 502.

In the event that the responding electronics device makes a determination at block 504 that a SIR bit pattern has been detected and then causes an ACK bit pattern to be transmitted at block 506, the receiver sensor pixel of the requesting electronics device receives the ACK bit pattern and outputs signals representing the corresponding intensity levels, as indicated by block 508. A determination is then made by circuitry of the requesting electronics device as to whether the ACK bit pattern has been detected, as indicated by block 509. If so, the communications session commences and optical information signals are communicated between the requesting and the responding electronics devices, as indicated by block 510. If not, the process may terminate, or it may repeat continuously or periodically by returning immediately or after a predetermined delay period to block 501.

The process depicted by the flowchart shown in FIG. 6 may be performed in a variety of ways. Those skilled in the art will understand, in view of the description provided herein, that many variations may be made to the process while still allowing the goals of the invention to be achieved. For example, the requesting electronics device may simply cause optical information signals to be sent over the link without using a SIR bit pattern to inform the responding electronics device that information signals are about to be sent. Likewise, transmission of the ACK pattern may be eliminated. The requesting electronics device may simply repeatedly send the information signals until it is satisfied that they have been received by the responding electronics device. Alternatively, the requesting electronics device may simply repeatedly send the information signals until it receives an ACK pattern from the responding electronics device indicating that the information signals have been received. Also, additional functionality not shown in FIG. 6 may be added to the process, such as, for example, error correction functionality.

It should be noted that the invention has been described with reference to a few illustrative embodiments for the purposes of demonstrating the principles and concepts of the invention. The invention is not limited to these embodiments, as will be understood by persons of ordinary skill in the art in view of the description provided herein. Those skilled in the art will understand that modifications may be made to the embodiments described herein and that all such modifications are within the scope of the invention.

What is claimed is:

1. A system for communicating over an optical communications link, the system comprising:
at least a first electronics device, the first electronics device comprising:
a first display device, the first display device including a plurality of display pixels and a plurality of sensor pixels, each display pixel being controllable to switch between at least first and second optical display conditions, each sensor pixel being capable of sensing light and producing an electrical sense signal associated with the sensed light, wherein at least one of the display pixels is used as a first transmitter pixel and wherein at least one of the sensor pixels is used as a first receiver pixel; and
a first controller, the first controller being configured to receive one or more information bits to be transmitted over an optical communications link and to cause the first transmitter pixel to switch between the optical display conditions to produce a modulated optical signal representative of the one or more information bits received by the controller, and wherein the first controller is configured to read the electrical sense signal produced by the first receiver pixel and to interpret the electrical sense signal read from the first receiver pixel as one or more information bits received over the optical communications link.

2. The optical communications system of claim 1, wherein each of the display pixels includes at least one liquid crystal (LC) that switches from one of the optical display conditions to another of the optical display conditions in response to an electrical switching signal being received by the display pixel, and wherein each sensor pixel includes at least one photodetector for sensing light impinging thereon and producing the electrical sense signal, the first controller reading the first receiver pixel by causing an electrical read signal to be applied to the first receiver pixel, wherein application of the electrical read signal to the first receiver pixel causes the electrical sense signal produced by the first receiver pixel to be sent to the first controller for interpretation by the first controller as one or more information bits.

3. The optical communications system of claim 2, wherein the display device is an active matrix liquid crystal display (AMLCD) device.

4. The optical communications system of claim 3, wherein each display pixel includes at least a red LC, a blue LC and a green LC, and wherein each LC is a cholesteric LC.

5. The optical communications system of claim 4, wherein the first optical condition of the first transmitter pixel corresponds to the red, green and blue LCs of the first transmitter pixel being transmissive to red, green and blue light, respectively, and wherein the second optical condition of the first transmitter pixel corresponds to the red, green and blue LCs of the first transmitter pixel being opaque to red, green and blue light, respectively.

6. The optical communications system of claim 5, wherein when the first transmitter pixel is in the first optical condition, white light is emitted from the first transmitter pixel to represent a logic 1 bit in the modulated optical signal, and wherein when the first transmitter pixel is in the second optical condition, substantially no light is emitted from the first transmitter pixel to represent a logic 0 bit in the modulated optical signal.

7. The optical communications system of claim 5, wherein when the first transmitter pixel is in the first optical condition, white light is emitted from the first transmitter pixel to represent a logic 0 bit in the modulated optical signal, and wherein when the first transmitter pixel is in the second optical condition, substantially no light is emitted from the first transmitter pixel to represent a logic 1 bit in the modulated optical signal.

8. The optical communications system of claim 1, further comprising:
at least a second electronics device comprising:
a second display device, the second display device including a plurality of display pixels and a plurality of sensor pixels, each display pixel of the second display device being controllable to switch between at least first and second optical display conditions, each sensor pixel of the second display device being capable of sensing light and producing a second electrical sense signal associated with the sensed light, wherein at least one of the display pixels of the second display device is used as a second transmitter pixel and wherein at least one of the sensor pixels of the second display device is used as a second receiver pixel; and
a second controller, the second controller being configured to receive one or more information bits to be transmitted over the optical communications link and to cause the second transmitter pixel to switch between the optical display conditions to produce a second modulated optical signal representative of the one or more information bits received by the second controller, and wherein the second controller is configured to read the second electrical sense signal produced by the second receiver pixel of the second display device and to interpret the second electrical sense signal as one or more information bits received by the second electronics device over the optical communications link.

9. The optical communications system of claim 8, wherein when the first and second transmitter pixels are in the first optical conditions, white light is emitted from the first and second transmitter pixels to represent respective logic 1 bits in the respective first and second modulated optical signal, and wherein when the first and second transmitter pixels are in the second optical condition, substantially no light is emitted from the first and second transmitter pixels to represent respective logic 0 bits in the respective first and second modulated optical signals.

10. The optical communications system of claim 8, wherein when the first and second transmitter pixels are in the first optical conditions, white light is emitted from the first and second transmitter pixels to represent respective logic 0 bits in the respective first and second modulated optical signal, and wherein when the first and second transmitter pixels are in the second optical condition, substantially no light is emitted from the first and second transmitter pixels to represent respective logic 1 bits in the respective first and second modulated optical signals.

11. A method for communicating over an optical communications link, the method comprising:
providing a first electronics device having a first display device and a first controller, the first display device comprising a plurality of display pixels and a plurality of sensor pixels, wherein at least one of the display pixels is used as a first transmitter pixel and wherein at least one of the sensor pixels is used as a first receiver pixel; and
in the first controller, receiving one or more information bits to be transmitted over an optical communications link and causing the first transmitter pixel to switch between at least first and second optical display conditions to produce a first modulated optical signal representative of one or more information bits.

12. The method of claim 11, further comprising:
providing a second electronics device comprising a second display device and a second controller, the second display device including a plurality of display pixels and a plurality of sensor pixels, wherein at least one of the display pixels of the second display device is used as a second transmitter pixel and wherein at least one of the sensor pixels of the second display device is used as a second receiver pixel; and
sensing the first modulated optical signal with the second receiver pixel and converting the first modulated optical signal into a second electrical sense signal.

13. The method of claim 12, further comprising:
in the second controller, interpreting the second electrical sense signal as one or more information bits.

14. The method of claim 13, further comprising:
in the second controller, receiving one or more information bits to be transmitted over the optical communications link and causing the second transmitter pixel to switch between at least first and second optical display conditions to produce a second modulated optical signal representative of one or more information bits.

15. The method of claim 14, further comprising:
causing the second modulated optical signal representing the one or more information bits to be transmitted over the optical communications link.

16. The method of claim 15, further comprising:
sensing the second modulated optical signal with the first receiver pixel and converting the second modulated optical signal into a first electrical sense signal.

17. The method of claim 16, further comprising:
in the first controller, interpreting the first electrical sense signal as one or more information bits.

18. The method of claim 12, further comprising:
in the first controller, prior to the first controller causing the first transmitter pixel to switch between at least first and second optical display conditions to produce a first modulated optical signal representative of one or more information bits, causing the first transmitter pixel to switch between said at least first and second optical display conditions to produce an optical training signal representative of one or more bits of a training sequence; and
prior to sensing the first modulated optical signal with the second receiver pixel, performing an algorithm in the second controller that determines whether or not one or more sensor pixels of the second display device have sensed the optical training sequence, and if so, selecting said one or more sensor pixels of the second display device to be used as the second receiver pixel.

19. The method of claim 18, wherein the algorithm performed in the second controller makes the determination as to whether or not one or more sensor pixels of the second display device have sensed the optical training sequence by reading electrical sense signals produced by the sensor pixels of the second display device and comparing the electrical sense signals read to a predetermined threshold value to determine whether the electrical sense signals read are equal to or greater than the predetermined threshold value.

20. The method of claim 18, wherein the first and second display devices are different in size.
